(19) United States
(12) Patent Application Publication
(10) Pub. No.: US 2018/0163929 A1
(43) Pub. Date: Jun. 14, 2018

(54) LIGHTING DEVICE

(71) Applicant: Samsung Electronics Co., Ltd., Suwon-si (KR)

(72) Inventors: Kyu-ho Jang, Suwon-si (KR); Ki-du Kim, Suwon-si (KR)

(21) Appl. No.: 15/533,963

(22) PCT Filed: Jan. 25, 2016
(86) PCT No.: PCT/KR2016/000781

§ 371 Date: Jun. 7, 2017

(30) Foreign Application Priority Data
Jan. 28, 2015 (KR) 10-2015-0013551

(51) Int. Cl. F21K 9/272; F21V 3/02; F21V 23/06

(52) U.S. Cl. CPC F21K 9/272; F21Y 2115/10; F21V 23/06; F21V 3/02

(57) ABSTRACT

Provided is an illumination device. The illumination device may include side-view type LED packages mounted on a substrate. The substrate and the side-view type LED packages may be inserted into a transparent or semitransparent cover unit. The side-view type LED packages may be mounted on at least one of a first surface and a second surface of the substrate, and may have different light-emitting directions from each other.

### TECHNICAL FIELD

The present disclosure relates to illumination devices, and more particularly, to illumination devices having a lateral-surface light-emitting diode (LED).

### BACKGROUND ART

An illumination device is generally used for securing a clear view in a dark place, expressing a visual effect of an advertisement, or having an aesthetic purpose. A light source of an illumination device may include an incandescent light, a fluorescent light, or a halogen light. In recent years, a light-emitting diode (LED) is used as a light source.

Of the illumination devices, a fluorescent lamp that is widely used is operated by being connected to a stabilizer as an auxiliary device. Ultraviolet rays are generated by colliding thermal electrons emitted from a filament of the fluorescent lamp that is preheated by the stabilizer with mercury electrons inside the fluorescent lamp, and the ultraviolet rays stimulate a fluorescence material, and thus, visible light is emitted to the outside.

Recently, illumination devices that use LEDs are used as a substitution for fluorescent lamps. The LEDs used in the illumination devices are employed using a top-view method, and thus, a module mounting area greater than an LED package is required. Accordingly, the size of a cover unit that constitutes an external shape of an illumination device may be relatively increased, and thus, the cover unit may not be easily applied to an illumination device, in particular, a T5 size illumination device.

### DETAILED DESCRIPTION OF THE INVENTION

### Technical Problem

Provided are illumination devices having a lateral-surface light-emitting diode (LED). Provided are illumination devices that may substitute fluorescent lamps and may be applied to illumination devices of T8 size and T5 size.

### Technical Solution

According to an aspect of an exemplary embodiment, an illumination device includes: a substrate; a side-view type light-emitting diode (LED) package mounted on the substrate; a cover unit that surrounds the substrate and the side-view type LED package; and caps formed on both edges of the cover unit.

The side-view type LED package may include a plurality of side-view type LED packages arranged in a direction on a surface of the substrate.

The side-view type LED packages may include: first side-view type LED packages formed to have a first light-emitting direction; and second side-view type LED packages formed to have a second light-emitting direction.

The first light-emitting direction and the second light-emitting direction may be different from each other.

The first side-view type LED packages and the second side-view type LED packages may be alternately arranged.

The first side-view type LED packages and the second side-view type LED packages may face each other.

The first side-view type LED packages and the second side-view type LED packages may be parallel to each other.

The side-view type LED package may include at least one first side-view type LED package formed on a first surface of the substrate and at least one second side-view type LED package formed on a second surface of the substrate.

The first surface and the second surface of the substrate may be different from each other.

The illumination device may further include at least one of light-emitting devices mounted on at least one of a surface and another surface, respectively, of the first side-view type LED package and the second side-view type LED package.

The illumination device may further include a terminal that outwardly protrudes from each of the caps and supplies external power

The illumination device may further include a power supply unit formed in each of the caps.

The cover unit may be formed of a transparent or semitransparent material and may have a straight tube shape; and an inner side thereof is empty.

The side-view type LED package may include at least one light-emitting device in a mold structure.

The at least one light-emitting device may be mounted in a recess unit formed on a side surface of the mold structure.

The side-view type LED package may be connected to the substrate through an electrode lead.

### Advantageous Effects of the Invention

According to the exemplary embodiments, an illumination device that includes side-view type LED packages formed on at least a surface of a substrate may be provided. Since the side-view type LED packages are formed on the substrate, an overall size of a coupled body of the substrate and the side-view type LED packages may be reduced. The size of a cover unit that surrounds the substrate and the side-view type LED packages may be reduced and the beam size of the illumination device may be increased. The illumination device according to the exemplary embodiments may be applied to not only to an illumination device of T8 size but also to an illumination device of T5 size.

### DESCRIPTION OF THE DRAWINGS

FIG. 1 is a schematic perspective view of an illumination device according to an exemplary embodiment;

FIG. 2 is a cross-sectional view taken along a line 11-12 of the illumination device of FIG. 1;

FIG. 3 is a cross-sectional view taken along a line m1-m2 of the illumination device of FIG. 1;

FIG. 4 is a cross-sectional view of a light-emitting diode (LED) mounted on an illumination device according to an exemplary embodiment;

FIG. 5A is a schematic perspective view of an illumination device according to another exemplary embodiment;

FIG. 5B is a plan view of an upper part of the illumination device of FIG. 5A;

FIG. 5C is a lateral cross-sectional view of the illumination device of FIG. 5A;

FIG. 6A is a schematic perspective view of an illumination device according to another exemplary embodiment;

FIG. 6B is a plan view of the illumination device of FIG. 6A;

FIG. 6C is a lateral cross-sectional view of the illumination device of FIG. 6A;

FIG. 7A is a schematic perspective view of an illumination device according to another exemplary embodiment;

FIG. 7B is a lateral cross-sectional view of the illumination device of FIG. 7A.

### MODE OF THE INVENTION

Reference will now be made in detail to exemplary embodiments, examples of which are illustrated in the accompanying drawings, wherein like reference numerals refer to like elements throughout. In the drawings, the sizes or thicknesses of constituent elements are exaggerated for clarity.

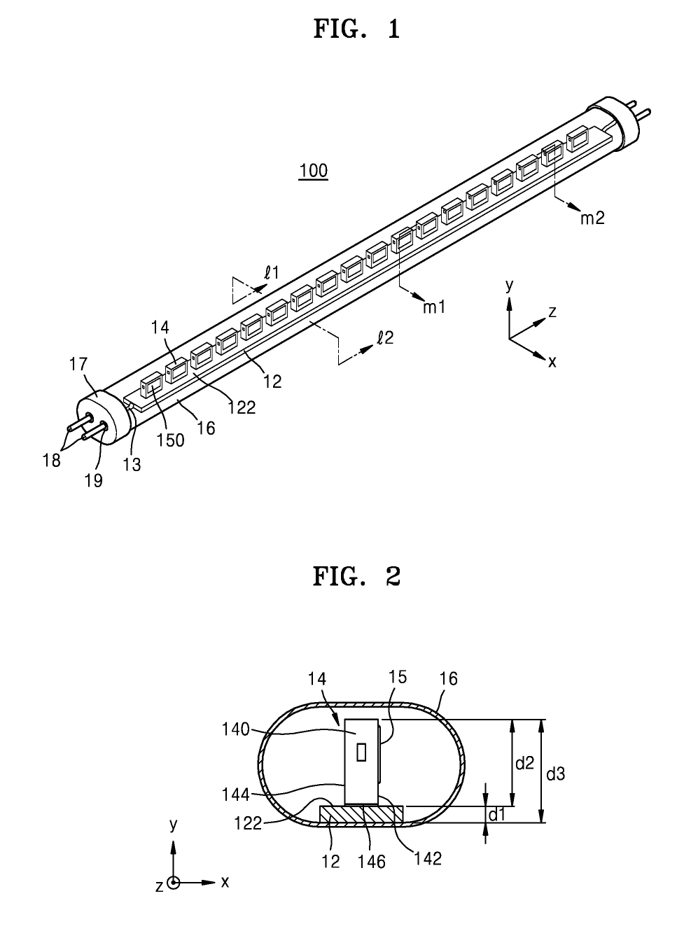

FIG. 1 is a schematic perspective view of an illumination device 100 according to an exemplary embodiment.

Referring to FIG. 1, the illumination device 100 according to an exemplary embodiment may include a plurality of side-view type LED packages 14 mounted on a substrate 12. Each of the side-view type LED packages 14 may include a light-emitting device 15. The side-view type LED package 14 and the substrate 12 on which the side-view type LED package 14 is mounted may be inserted into or placed in a transparent cover unit 16. Caps 17 may be respectively formed on both edges of the cover unit 16 while the cover unit 16 surrounds the substrate 12 and the side-view type LED packages 14. The substrate 12 may be a printed circuit board (PCB) 12. A terminal unit 18 for supplying external power to the PCB 12 may be formed on the cap 17. The terminal unit 18 may protrude from the cap 17.

The terminal unit 18 supplies external power to the light-emitting device 15. The terminal unit 18 may protrude from the cap 17 so as to be coupled to an external socket. An alternate current of 220V or 110V which is general external power may be supplied to the light-emitting devices 15 through the terminal unit 18. The cap 17 may include a power supply unit (PSU) 19 formed therein. The external power supplied through the terminal unit 18 may be converted to a direct current (DC) power in the PSU 19 of the cap 17, and the DC power may be supplied to the side-view type LED packages 14 through a power source connecting unit 13 and the substrate 12, and thus, the light-emitting devices 15 may be operated.

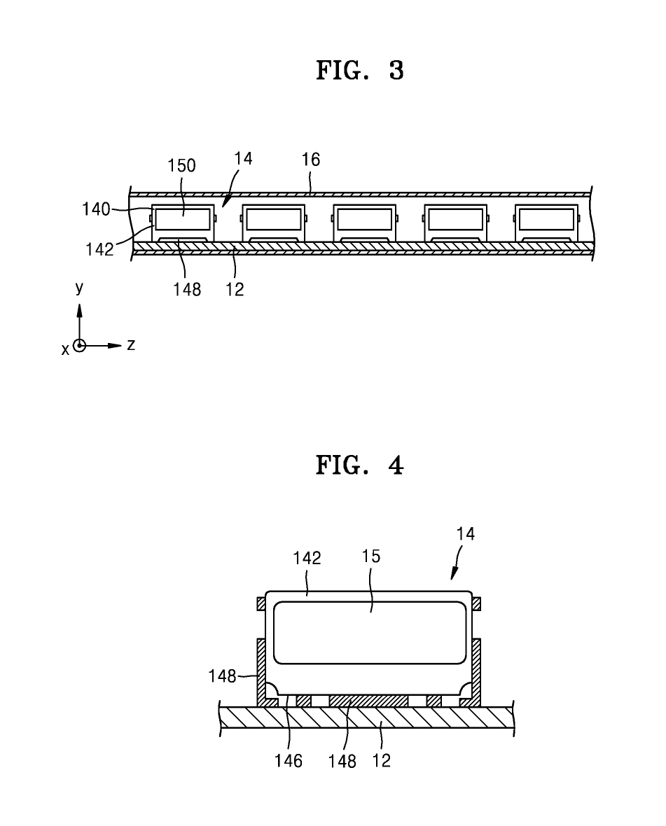

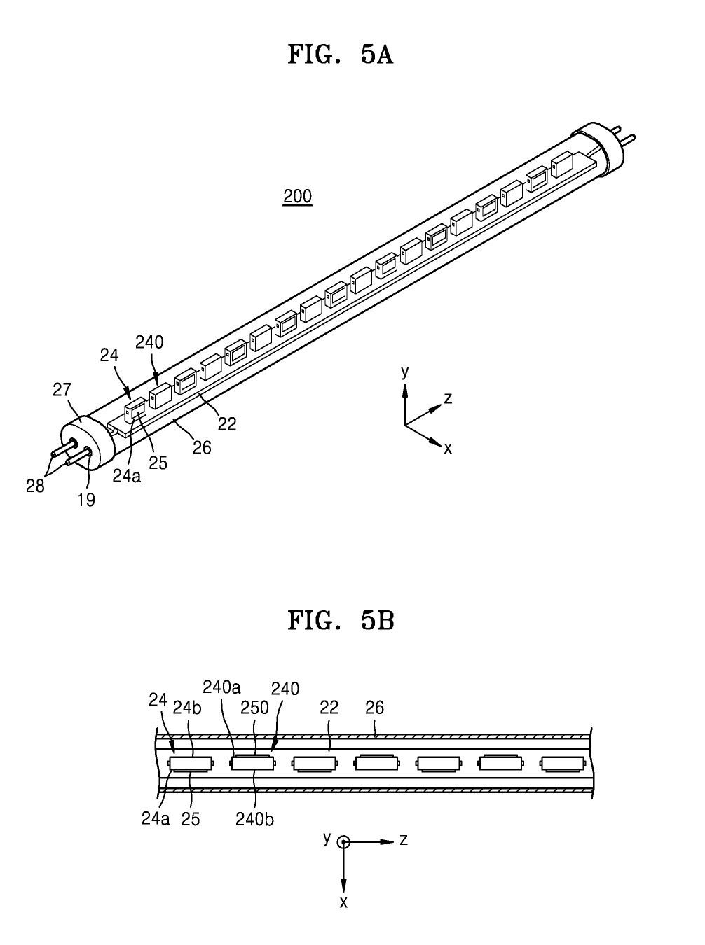

FIG. 2 is a cross-sectional view taken along a line 11-12 of the illumination device 100 of FIG. 1, that is, a lateral cross-sectional view of the illumination device 100. FIG. 3 is a cross-sectional view taken along a line m1-m2 of the illumination device 100 of FIG. 1.

Referring to FIGS. 2 and 3, the illumination device 100 according to the current exemplary embodiment may include the side-view type LED packages 14 each having the light-emitting device 15 and the side-view type LED packages 14 are mounted on an upper surface 122 of the substrate 12. In each side-view type LED package 14 of the illumination device 100 according to the current exemplary embodiment, side-view type LEDs 150 may be mounted on a first side surface 142 of the side-view type LED package 14, and a lower surface 146 of the side-view type LED package 14 may be directly mounted on an upper surface 122 of the substrate 12. An electrode lead 148 protrude from the side-view type LED package 14 may be electrically connected to the substrate 12 and may receive external power.

A plurality of the side-view type LED packages 14 may be arranged in a row on the substrate 12 in a certain direction, for example, in a direction of the substrate 12, for example, in a length direction of the substrate 12. Gaps between the side-view type LED packages 14 may be equal to each other, but is not limited thereto. The number of the side-view type LED packages 14 formed on the substrate 12 is not specifically limited. The light-emitting device 15 may be mounted on at least one of the first side surface 142 and a second side surface 144 of each of the side-view type LED packages 14. In FIGS. 2 and 3, the light-emitting device 15 is depicted as being mounted on the first side surface 142 of the side-view type LED package 14. In the current exemplary embodiment, the light-emitting device 15 is mounted on the first side surface 142 of the side-view type LED package 14, but the mounting of the light-emitting device 15 is not limited thereto.

The substrate 12 may be a printed circuit board (PCB) in which a conductive circuit pattern is formed on an insulating base layer. For example, the substrate 12 may include a metal PCB, a flexible PCB, a ceramic PCB, or a metal core (MC) PCB. The substrate 12 may be a metal substrate for increasing a heat dissipation characteristic or a substrate having a metal core. A surface of the substrate 12 may be a material layer having high reflectivity to reflect light emitted from the light-emitting device 15.

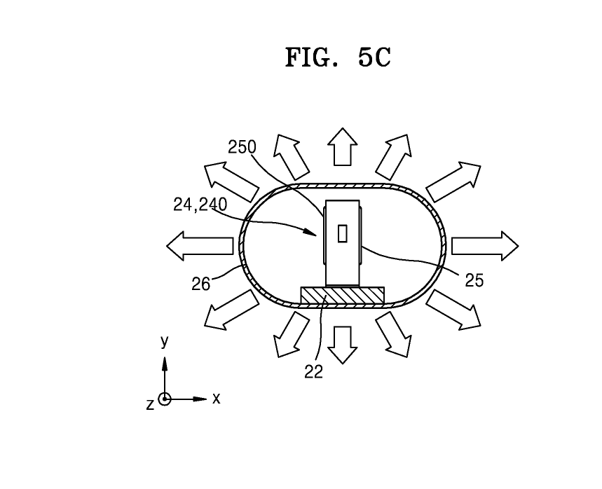

At least one of the light-emitting devices 15 may be mounted in a mold structure of the side-view type LED package 14. FIG. 4 is a cross-sectional view of the side-view type LED package 14 mounted on an illumination device 100 according to an exemplary embodiment. Referring to FIG. 4, the side-view type LED package 14 is formed on the substrate 12, and may be connected to a circuit unit of the substrate 12 through the electrode lead 148. The light-emitting device 15 may be mounted on the first side surface 142 or the second side surface 144 of the side-view type LED package 14. The side-view type LED package 14 may include, for example, a package mold having a recess unit for mounting the light-emitting device 15. The light-emitting device 15 is mounted in the recess unit and may be operated by receiving external power. The external power may be converted to DC power through the terminal unit 18 and the cap 17 depicted in FIG. 1. The DC power may be supplied to the side-view type LED package 14 through the substrate 12 and the electrode lead 148, and thus, the light-emitting device 15 may be operated. The numbers, locations, or arrangement types of light-emitting devices 15 mounted on the side-view type LED package 14 may be controlled in various ways.

The light-emitting device 15 may be a semiconductor that may generate light by receiving external power, for example, a light-emitting diode (LED). The light-emitting device 15 may emit light having various wavelengths, and may emit red, blue, or green color light according to the kind of material included in the light-emitting device 15. The light-emitting device 15 may be formed by packaging a plurality of light-emitting diode chips in a free mold method by using a lead frame, a mold frame, fluorescent or transparent filler and mounted on the side-view type LED package 14. Also, the light-emitting device 15 may be mounted on the side-view type LED package 14 by using a wire bonding method or a flip-chip bonding method.

The cover unit 16 may transmit and diffuse light generated from the light-emitting device 15 mounted in the side-view type LED package 14. The cover unit 16 may perform a function of maintaining or protecting the shape of the substrate 12 and the side-view type LED package 14. The cover unit 16 may be formed of a transparent or a semitransparent material having high transparency. For example, the cover unit 16 may be formed of a ceramic material, such as, glass, alumina Al₂O₃, a polycarbonate (PC) group resin, or a polymethylmethacrylate (PMMA) group resin. Both edges of the cover unit 16 may be opened to insert the substrate 12 and the side-view type LED packages 14 therein and may have a straight tube shape, an inside thereof is empty. The substrate 12 and the side-view type LED packages 14 may be inserted into and mounted in the straight tube shape cover unit 16 through the both opened edges of the cover unit 16 while the side-view type LED packages 14 are mounted on the substrate 12. As depicted in FIG>2, the cross-sectional view of the both edges may have an oval shape, but the shape of the both edges is not limited thereto. For example, the shape of the cross-sectional view of the both edges may be a circular shape, an oval shape, a polygonal shape, or a combination of these shapes.

The size of the cover unit 16 may be determined according to the size of the substrate 12 and the size of the side-view type LED package 14 mounted on the substrate 12. A width and a thickness dl of the substrate 12 may be a few mm, for example, the substrate 12 may have a width of 4 mm and the thickness dl of approximately 1 mm. The side-view type LED package 14 formed on the substrate 12 may have a height d2 of a few mm, for example, approximately 3 mm. If the substrate 12 has a thickness of approximately 1 mm and the side-view type LED package 14 has a height d2 of approximately 3 mm and when the side-view type LED package 14 is formed on the substrate 12, a height d3 of a coupled body of the substrate 12 and the side-view type LED package 14 may be approximately 4 mm. The cover unit 16 may be formed to have a size into which the substrate 12 and the side-view type LED package 14 are inserted. When the substrate 12 has a width of approximately 4 mm and the height d3 of the coupled body of the substrate 12 and the side-view type LED package 14 is approximately 4 mm, the cover unit 16 may be formed to have a width and a height respectively may be approximately 5 mm and 10 mm. In this manner, since the side-view type LED package 14 is formed on the substrate 12, the cover unit 16 having a small size may be employed. A beam angle of the side-view type LED package 14 may be approximately 201 degrees, and the beam angle of light emitted from the side-view type LED package 14 may be increased by the cover unit 16.

The illumination device 100 according to the current exemplary embodiment may be an illumination device that can substitute a fluorescent lamp, and may realize the same optical characteristics and optical efficiency as an LED tube of a T* size by employing the side-view type LED package 14. Also, the illumination device 100 may be formed to a T5 size by effectively configuring an overall size of the coupled body of the substrate 12 and the side-view type LED package 14.

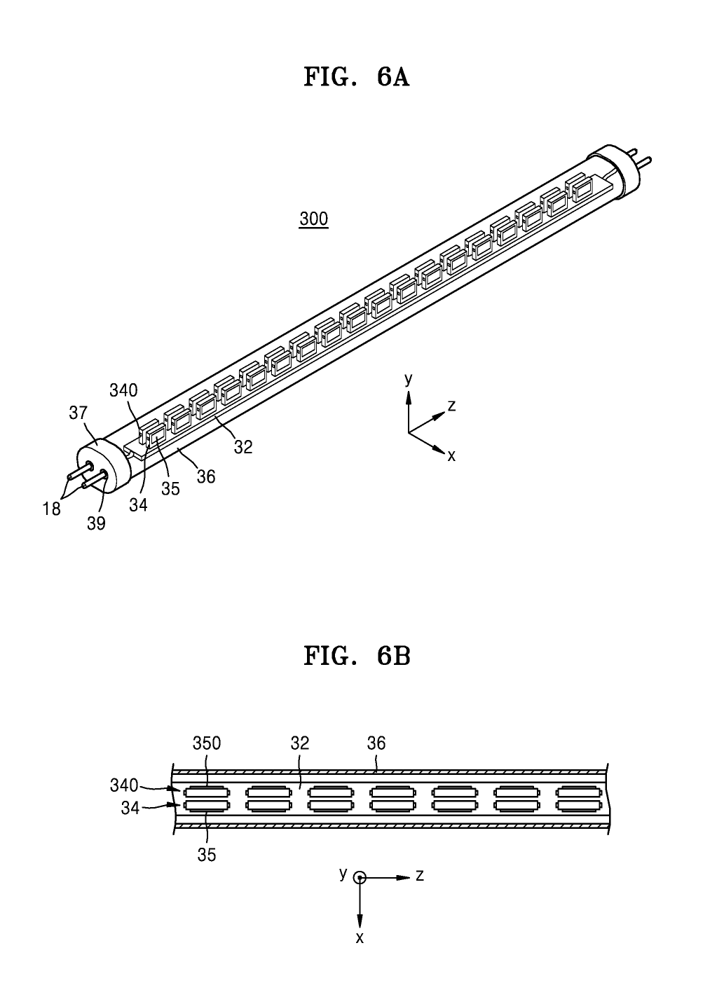

FIG. 5A is a schematic perspective view of an illumination device 200 according to another exemplary embodiment. FIG. 5B is a plan view of an upper part of the illumination device 200 of FIG. 5A.

Referring to FIGS. 5A and 5B, the illumination device 200 according to the current exemplary embodiment may include a plurality of first side-view type LED packages 24 formed in a row in a first light-emitting direction and second side-view type LED packages 240 formed on a row in a second emitting-direction on a surface of a substrate 22. Here, the first light-emitting direction or the second light-emitting direction may denote a surface direction of the first side-view type LED packages 24 and the second side-view type LED packages 240 on which first and second light-emitting devices 25 and 250 are mounted. For example, each of the first side-view type LED packages 24 may include a first surface 24a and a second surface 24b, and the first light-emitting device 25 may be formed on the first surface 24a, and the surface direction of the first surface 24a of the first side-view type LED packages 24 may be an x-axis direction. Accordingly, the first light-emitting direction may be the x-axis direction. Also, each of the second side-view type LED packages 240 may include a first surface 240a and a second surface 240b, and the second light-emitting device 250 may be formed on the first surface 240a of the second side-view type LED packages 240. The surface direction of the first surface 240a of the second side-view type LED packages 240 may be an -x-axis direction.

In this way, the illumination device 200 according to the current exemplary embodiment may include the first side-view type LED packages 24 having the first light-emitting direction and the second side-view type LED packages 240 having the second light-emitting direction. Here, the first light-emitting direction and the second light-emitting direction may be different from each other. For example, as depicted in FIGS. 5A and 5B, the first light-emitting direction and the second light-emitting direction respectively are an x-axis direction and an -x-axis direction that are completely opposite directions, that is, 180 degrees different from each other. However, although the first light-emitting direction and the second light-emitting direction are not completely opposite directions, they may be light-emitting directions that are not in the same light-emitting direction.

In the illumination device 200 according to the current exemplary embodiment, the substrate 22 and the first and second side-view type LED packages 24 and 240 may be inserted into a cover unit 26 as a state of coupling to each other. Caps 27 may be respectively formed on both edges of the cover unit 26, and a terminal unit 28 that supplies external power to the substrate 22 may be formed on the caps 27, and the terminal unit 28 protrudes outwards from the caps 27. The external power may be supplied o the substrate 22 and the first and the side-view type LED packages 24 and 240 through the terminal unit 28 and a power supply unit 29 formed in the cap 27.

FIG. 5C is a lateral cross-sectional view of the illumination device 200 of FIG. 5A.

Referring to FIG. 5C, lights respectively emitted from the first and second light-emitting devices 25 and 250 of the first and second side-view type LED packages 24 and 240 are diffused by the cover unit 26 and are emitted to the outside of the illumination device 200. Beam angles of the first and second side-view type LED packages 24 and 240 may be, for example, approximately 120 degrees. When lights emitted from the first and second side-view type LED packages 24 and 240 are emitted to the outside of the illumination device 200, the beam angles may be greater than 300 degrees, for example, may be expanded to about 320 degrees to about 360 degrees by being diffused by the cover unit 26. As a result, lights respectively emitted from the first and second light-emitting devices 25 and 250 of the first and second side-view type LED packages 24 and 240 are diffused by passing through the cover unit 26, and thus, may be emitted to the outside of the illumination device 200 substantially through the whole surface of the cover unit 26.

In the case of the illumination device 200 according to the current exemplary embodiment, the first side-view type LED packages 24 and the second side-view type LED packages 240 that are formed in different directions from each other on a first surface of the substrate 22. A plurality of the first and second side-view type LED packages 24 and 240 may be formed in a direction, for example, in a z-axis direction. The first side-view type LED packages 24 having a first light-emitting direction and the second side-view type LED packages 240 having a second light-emitting direction may be alternately disposed, but the disposition of the first and second side-view type LED packages 24 and 240 is not limited thereto.

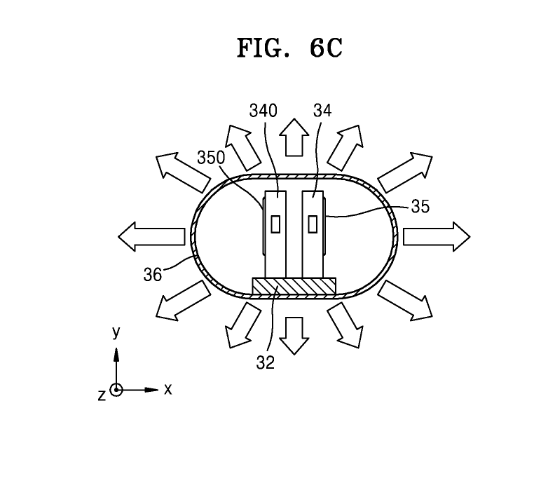

FIG. 6A is a schematic perspective view of an illumination device 300 according to another exemplary embodiment. FIG. 6B is a plan view of the illumination device 300 of FIG. 6A.

Referring to FIGS. 6A and 6B, the illumination device 300 according to the current exemplary embodiment may include at least one of first side-view type LED packages 34 and at least one of second side-view type LED packages 340 respectively formed on a surface of a substrate 32. The first side-view type LED packages 34 and the second side-view type LED packages 340 may have different light emitting direction from each other, for example, the first side-view type LED packages 34 may have a first light-emitting direction, for example, an x-axis direction, and the second side-view type LED packages 340 may have a second light-emitting direction, for example, an -x-axis direction. Here, the first and second light-emitting directions denote the directions of mounting first and second light-emitting devices 35 and 350 or the directions of emitting light generated from the first and second light-emitting devices 35 and 350 to the outside of the first and second side-view type LED packages 34 and 340. The first and second side-view type LED packages 34 and 340 may be formed facing each other. For example, a rear surface of each of the first side-view type LED packages 34 on which the first light-emitting device 35 is formed may face a rear surface of each of the second side-view type LED packages 340 on which the second light-emitting device 350 is formed. However, the first and second side-view type LED packages 34 and 340 may not be correctly face each other, and the direction of forming the first side-view type LED packages 34 and the direction of forming the second side-view type LED packages 340 may be the same, for example, in a z-axis direction, and may be formed to face each other.

The first and second side-view type LED packages 34 and 340 formed on a surface of the substrate 32 respectively may be arranged in a direction, for example, in a z-axis direction, and the first and second side-view type LED packages 34 and 340 may be formed parallel to each other. The illumination device 300 according to the current exemplary embodiment may be formed by inserting the substrate 32 and the first and second side-view type LED packages 34 and 340 into the cover unit 36 in a state that the substrate 32 and the first and second side-view type LED packages 34 and 340 are coupled to each other. The caps 37 may be respectively formed on both edges of the cover unit 36, and each of the caps 37 may include a terminal unit 38 that protrudes outwards from the cap 37 to supply external power to the first and second light-emitting devices 35 and 350. The external power may be supplied to the substrate 32 and the first and second side-view type LED packages 34 and 340 through the terminal unit 38 via a power supply unit 39 formed in the cap 37.

FIG. 6C is a lateral cross-sectional view of the illumination device 300 of FIG. 6A.

Referring to FIG. 6C, lights respectively emitted from the first and second light-emitting devices 35 and 350 of the first and second side-view type LED packages 34 and 340 may be diffused by the cover unit 36 and may be emitted to the outside of the illumination device 300. Beam angles of the first and second side-view type LED packages 34 and 340 respectively may be, for example, approximately 120 degrees. When lights emitted from the first and second side-view type LED packages 34 and 340 are emitted to the outside of the illumination device 300, the beam angles may be greater than 300 degrees, for example, may be emitted to the outside of the illumination device 300 by being expanded to about 320 degrees to about 360 degrees substantially through the whole surface of the cover unit 36. As a result, lights respectively emitted from the first and second light-emitting devices 25 and 250 of the first and second side-view type LED packages 24 and 240 are diffused by passing through the cover unit 26, and thus, may be emitted to the outside of the illumination device 200 substantially through the whole surface of the cover unit 26.

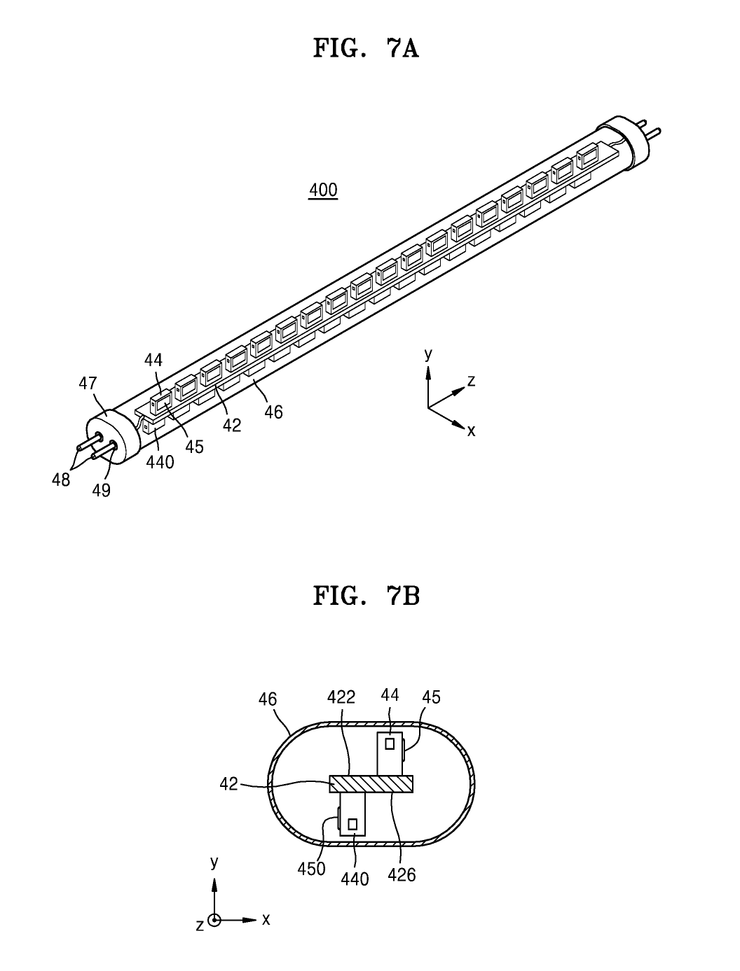

FIG. 7A is a schematic perspective view of an illumination device 400 according to another exemplary embodiment.

Referring to FIG. 7A, the illumination device 400 according to the current exemplary embodiment may include at least one of first side-view type LED packages 44 formed on a first surface 422 of a substrate 42 and at least one of second side-view type LED packages 440 formed on a second surface 426 of the substrate 42. Here, the first and second surfaces 422 and 426 may be different from each other. The first surface 422 is an upper surface of the substrate 42 and the second surface 426 may be a lower surface of the substrate 42 or vice versa. A light-emitting device 45 may be mounted on a side surface of each of the first side-view type LED packages 44. Also, a light-emitting device 450 may be mounted on a side surface of each of the second side-view type LED packages 440. However, the locations of the light-emitting devices 45 and 450 of the first side-view type LED package 44 or the second side-view type LED package 440 are not limited thereto. The light-emitting device 45 may be mounted on at least one of a side surface and the other side surface of the first side-view type LED package 44. Also, the light-emitting device 450 may be mounted on at least one of a side surface and the other side surface of the second side-view type LED package 440.

The first side-view type LED packages 44 and the second side-view type LED packages 440 formed on the first surface 422 of the substrate 42 respectively may be arranged in a direction, for example, in a z-axis direction. The illumination device 400 according to the current exemplary embodiment may be formed by being inserted into a cover unit 46 in a state that the substrate 42 and the first and second side-view type LED packages 44 and 440 are coupled to each other. Caps 47 may be respectively formed on both edges of the cover unit 46, and each of the caps 47 may include a terminal unit 48 that protrudes outwards from the cap 47 to supply external power to the light-emitting devices 45 and 450. The external power may be supplied to the substrate 42 and the first and second side-view type LED packages 44 and 440 through the terminal unit 48 via a power supply unit 49 formed in the cap 47.

FIG. 7B is a lateral cross-sectional view of the illumination device 400 of FIG. 7A. Referring to FIG. 7C, lights respectively generated from the light-emitting devices 45 and 450 of the first and second side-view type LED packages 44 and 440 are diffused by the cover unit 46 and are emitted to the outside of the illumination device 400. Beam angles of the first and second side-view type LED packages 44 and 440 respectively may be 120 degrees. The beam angles of the lights when the lights are emitted to the outside of the illumination device 400 may be greater than approximately 320 degrees, for example, may be emitted to the outside of the illumination device 400 by being diffused in a range from about 320 degrees to about 360 degrees through substantially a whole surface of the over unit 46.

While one or more exemplary embodiments have been described with reference to the figures, it will be understood by those of ordinary skill in the art that various changes in form and details may be made therein without departing from the spirit and scope as defined by the following claims.

1. An illumination device comprising:
a substrate;
a side-view type light-emitting diode (LED) package mounted on the substrate;
a cover unit that surrounds the substrate and the side-view type LED package; and
caps formed on both edges of the cover unit.

2. The illumination device of claim 1, wherein the side-view type LED package comprises a plurality of side-view type LED packages arranged in a direction on a surface of the substrate.

3. The illumination device of claim 2, wherein the side-view type LED packages comprise:
first side-view type LED packages formed to have a first light-emitting direction; and
second side-view type LED packages formed to have a second light-emitting direction.

4. The illumination device of claim 3, wherein the first light-emitting direction and the second light-emitting direction are different from each other.

5. The illumination device of claim 3, wherein the first side-view type LED packages and the second side-view type LED packages are alternately arranged.

6. The illumination device of claim 3, wherein the first side-view type LED packages and the second side-view type LED packages face each other.

7. The illumination device of claim 3, wherein the first side-view type LED packages and the second side-view type LED packages are parallel to each other.

8. The illumination device of claim 1, wherein the side-view type LED package comprises at least one first side-view type LED package formed on a first surface of the substrate and at least one second side-view type LED package formed on a second surface of the substrate.

9. The illumination device of claim 8, wherein the first surface and the second surface of the substrate are different from each other.

10. The illumination device of claim 8, further comprising at least one light-emitting device mounted on at least one of a surface and another surface, respectively, of the first side-view type LED package and the second side-view type LED package.

11. The illumination device of claim 1, further comprising a terminal that outwardly protrudes from each of the caps and supplies external power.

12. The illumination device of claim 1, further comprising a power supply unit formed in each of the caps.

13. The illumination device of claim 1, wherein the cover unit is formed of a transparent or semitransparent material and has a straight tube shape and an inner side thereof is empty.

14. The illumination device of claim 1, wherein the side-view type LED package comprises at least one light-emitting device in a mold structure.

15. The illumination device of claim 14, wherein the at least one light-emitting device is mounted in a recess unit formed on a side surface of the mold structure.
